(19) United States
(12) Patent Application Publication
(10) Pub. No.: US 2012/0037615 A1
(43) Pub. Date: Feb. 16, 2012

(54) Induction Cookware for Keeping Food Warm

(75) Inventor: Timo Hafner, Radolfzell (DE)

(73) Assignee: Gastros AG, Zurich (DE)

(21) Appl. No.: 13/264,646

(22) PCT Filed: Apr. 29, 2010
(86) PCT No.: PCT/DE2010/000485

§ 371 Date: Oct. 14, 2011

(30) Foreign Application Priority Data
May 6, 2009 (DE) 102009025750.0

(51) Int. Cl. H05B 6/22; B05D 5/00

(52) U.S. Cl. 219/647; 427/128

(57) ABSTRACT

An item of induction cookware for keeping food warm comprises a base with ribs, between which the base is coated with a ferromagnetic material. According to the invention, the ferromagnetic material is divided into fields. This prevents constriction points in the ferromagnetic material, at which intense local heating can occur, which can cause the induction cookware to break.

### FIELD OF THE INVENTION

The present invention relates to an item of induction cookware, such as a bowl or a pan, for keeping food warm and which is provided especially to offer warm foods on buffets in the field of catering.

Cookware, such as pots and pans, is generally produced from an alloy that is compatible with food, e.g. a stainless steel or an aluminum alloy. If the cookware is intended to be heated by induction, its base includes a ferromagnetic alloy. Food-safe alloys are generally not magnetic and, due to their generally significant frequency range, cannot be heated by induction. By contrast, the ferromagnetic material can be heated by induction and forms a heating area for cookware of this type. In describing the induction cookware, reference will be made hereafter to a container. This is understood to include all vessels, platters, plates, cups, pots, pans, etc. that have the property of receiving, processing, presenting or keeping warm at least one foodstuff.

### BACKGROUND OF THE INVENTION

Known induction cookware that consists of metal has a ferromagnetic material in its base region that serves to convert an alternating magnetic field produced by a coil into heat, which is emitted to a foodstuff or to the induction cookware in order to heat said foodstuff.

Moreover, porcelain dishes that have a detachable induction element on their respective outer sides for heating prepared foods by means of induced eddy currents are known from document AT 009 021 U1, for example, said induction element preferably consisting entirely of an electrically conductive, flexible foil. The induction element should also preferably lie over the entire surface of the outer wall of the porcelain dishes and should be held in the lower contact area by an adhesive.

It is also known that a ferromagnetic material is applied as an induction element to the base of a dielectric dish before said dish undergoes a glazing process, and so, after the glazing process, the induction element is glazed in. This produces the benefit, inter alia, that the cookware is dishwasher safe.

One property of the known items of cookware is that a ferromagnetic material covers the entire base surface of the cookware. This means that an underside of a dinner plate, for example, is completely covered with the ferromagnetic plate. Also in the case of serving platters, which primarily consist of porcelain, completely coating the underside with a ferromagnetic material is a known process for keeping foods warm on a hot buffet, for instance, the warm-keeping function being achieved by means of induction.

However, experience has shown that, either as a result of an improper setting of the induction transmitter (warm-keeping oven), which generates the alternating magnetic field, or in particular platters or serving dishes and molds, so much energy from the induction transmitter is coupled into the ferromagnetic material that cookware which consists e.g. of porcelain can break, i.e. that the undesirable heat expansion can bring about cracks or fissures. This also means that too much energy is introduced into the porcelain container through the ferromagnetic material, as a result of which the cookware can be damaged. The cookware becomes unusable. It has been shown that the risk of the cookware breaking or rupturing during inductive heating increases with the size of the base surface of the cookware.

The problem addressed by the invention is that of optimizing the interaction between the induction transmitter and the ferromagnetic material that is arranged on a base of the cookware so that damage to the cookware is prevented.

### SUMMARY OF THE INVENTION

The present invention discloses that a ferromagnetic material on the base of an item of induction cookware is divided into fields by interruptions, the fields being limited to sub-areas of the base. Electrical eddy currents, which are generated by an alternating magnetic field of an induction transmitter, cannot continue beyond the interruptions in the ferromagnetic material, but rather are limited to the fields. The electrical eddy currents are limited to the fields of ferromagnetic material in areas that are smaller than the base of the induction cookware, which results in a more even distribution of heat to the surface of the base of the induction cookware and which prevents the breaking or rupturing of the induction cookware or at least reduces the risk of the breaking or rupturing of the induction cookware. The invention is provided in particular for induction cookware with large bases, in which the risk of stress cracks is high.

Ferromagnetic material is understood to be a material in which an alternating magnetic field induces eddy currents that are converted into heat by the electric resistance of the material or, more generally, a material that converts an alternating magnetic field into heat.

As a rule, the energy is coupled into the ferromagnetic element via one or more coils of one or more induction transmitters. These coils are arranged in a spiral shape in a flat circular surface in the induction transmitter, which can look similar to a conventional electric hot plate. This means that the generated alternating magnetic field is completely coupled into the ferromagnetic material which is provided on the base of the induction cookware to keep it warm and which is preferably disposed at a very small distance from it. The invention prevents extremely high temperatures and in particular an extremely uneven temperature distribution by dividing the ferromagnetic material into fields. Induction in fields that are smaller than the base of the induction cookware avoids extreme heat-induced material stress in the induction cookware and thus prevents cracking, breaking or shattering.

In one embodiment of the invention, the base of the induction cookware comprises at least one rib on its underside for reinforcement. The induction cookware can rest on this rib when it is placed upon a base. The rib is distanced from an edge of the base and ends at a distance from the edge of the base. A rib, especially a circumferential rib, can likewise be present on the edge of the base. The ferromagnetic material provided on the base to generate heat by induction is omitted from the at least one rib and is interrupted in the extension of the at least one rib up to the edge of the base of the induction cookware or up to another rib. In this way, the ferromagnetic material is divided into fields that cover subareas of the base.

In addition to or instead of the interruption in the extension of the at least one rib, the ferromagnetic material can also be interrupted laterally to the at least one rib, i.e. within its longitudinal extension, up to the edge of the base of the induction cookware or up to a further rib, and in this way can be divided into fields.

The fields into which the ferromagnetic material is divided preferably have a homogeneous surface, i.e. they are preferably round. They can also be oval or elliptical, for example, or they can be angular without internal corners, e.g. square, rectangular or polygonal. Constrictions and narrow points in the fields of ferromagnetic material, at which the field lines of the induced electric eddy currents are concentrated, should be avoided as much as possible. Compressing the electric field lines causes a locally increased production of heat, which unevenly heats the base of the induction cookware, thus resulting in the thermal stresses that can make the induction cookware crack or rupture. According to the present invention, this is avoided by shaping the fields of the ferromagnetic material without constrictions or narrow points.

The ferromagnetic material is particularly applied as a layer on an underside of the base of the induction cookware. It can be applied, for example, as a film, by powder coating or in some other way and, if necessary, can be stoved.

The invention is particularly intended to keep food warm on buffets in the field of catering. For this reason, one embodiment of the invention provides pans or bowls as the induction cookware. However, the invention can also be applied to plates, drinking glasses and other dishes.

The base of the induction cookware is preferably angular, in particular quadrangular, square or rectangular. These base shapes can easily be divided into fields that are at least approximately equal in shape and size, which brings about the desired even induction heating.

Induction cookware with a round base is also suitable for the invention. In this case, the invention provides for a ferromagnetic material that is arranged in a ring especially on, or also outside, the edge of the base and that surrounds the ferromagnetic material on the base of the induction cookware. The annular ferromagnetic material is separated from the surrounding material; there is neither electrically conductive nor magnetically conductive contact. The surrounding ring of ferromagnetic material improves the production of heat. In induction cookware with an angular base, this configuration is normally not necessary, but it is also not ruled out.

In particular, the induction cookware according to the invention consists of a dielectric material, preferably ceramic, porcelain or earthenware. The invention can also be applied in induction cookware consisting of glass, plastic or metal. This list is not conclusive.

The claimed formation and arrangement of the ferromagnetic material on the base of the induction cookware, particularly on buffet pans or catering pans, is principally intended only for keeping food warm and not for cooking.

### BRIEF DESCRIPTION OF THE DRAWINGS

In the following, the invention will be explained in greater detail on the basis of an embodiment represented in the drawing. The figures show a selection of induction cookware items according to the invention, as viewed from below at an angle to a base of the induction cookware.

FIGS. 1-4 show an induction cookware in the form of rectangular porcelain dishes; and

FIG. 5 shows an induction cookware that is mug-shaped.

### DETAILED DESCRIPTION OF THE PREFERRED EMBODIMENTS OF THE INVENTION

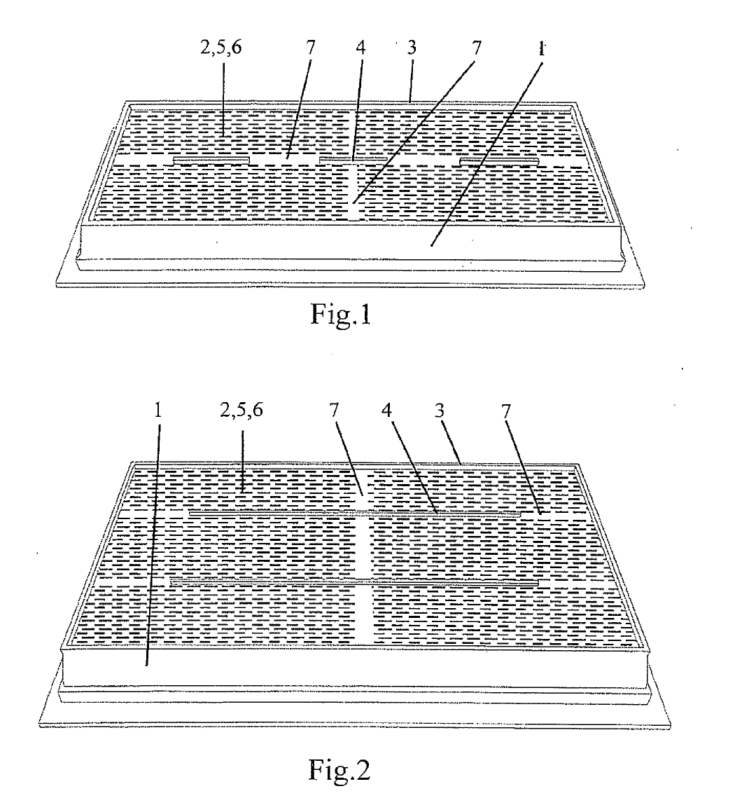

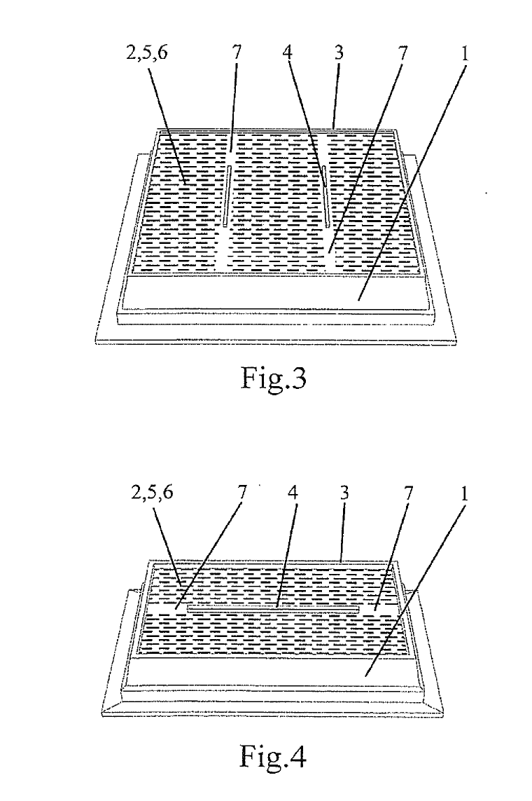

FIGS. 1 to 4 show the claimed induction cookware 1 in the form of rectangular porcelain dishes which are provided for the purpose of receiving food and keeping it warm. A base 2 of the induction cookware 1 is surrounded by a circumferential rib 3. Furthermore, the base 2 comprises one or more ribs 4 within the rib 3 that surrounds the base 2. In the embodiments, these ribs 4 are arranged on imagined lines along and/or transverse to the base 2 of the induction cookware. As is seen in FIG. 1, the ribs 4 can be interrupted. The ribs 4 are distanced from the rib 3 that surrounds the base 2; specifically, they are arranged at a lateral distance from the surrounding rib 3 and end at a distance from the surrounding rib 3. The ribs 4 are thus distanced from the edge of the base 2 of the induction cookware 1.

The base 2 of the induction cookware 1 has a coating 5 of a ferromagnetic material on its underside within the surrounding rib 3. Hereafter, said ferromagnetic material will be referred to as a ferromagnetic coating 5 or, briefly, as a coating 5. The ferromagnetic coating 5 can comprise silver oxide, for example. The coating 5 aids in the inductive heating of the base 2 in order to keep foods warm in the induction cookware 1 using an induction transmitter, which is not shown, e.g. on a buffet. The induction transmitter can look similar to a conventional electric hotplate. It comprises a coil for generating an alternating magnetic field that induces eddy currents in the ferromagnetic coating 5, said currents being converted into heat by the electric resistance of the coating 5.

The ferromagnetic coating 5 is not arranged over the entire surface of the base 2 of the induction cookware 1, but is instead divided into fields 6. On the ribs 4, the coating 5 has gaps that can be regarded as interruptions 7 and that proceed continuously in the extension of the ribs 4 up to the rib 3 that surrounds the base 2 and/or up to another rib 4, as can be seen in FIG. 1. The ferromagnetic coating 5 can also be divided into fields 6 by interruptions 7 transversely to the ribs 3, i.e. within its longitudinal extension, as can be seen in FIGS. 1 and 2.

The interruptions 7 divide the ferromagnetic coating 5 of the base 2 of the induction cookware 1 into separate fields 6, which are as equal in size and shape as possible. In FIG. 4, the base 2 is divided into two equal fields 6, which are half as large as the base 2. In FIGS. 1 to 3, the base 2 is divided into four, six and three fields 6, which occupy a corresponding fraction of a surface of the base 2. Eddy currents that are induced in the ferromagnetic coating 5 are limited to correspondingly small surfaces by the division into fields 6. This counteracts a locally uneven heating of the base 2 and thus also the thermal stresses that can cause the base 2 to crack. Dividing the ferromagnetic coating 5 of the base 2 brings about a more even distribution of heat and reduces thermal stresses; the risk that the induction cookware will be destroyed by thermal stresses is diminished.

The fields 6 of the thermal coating 5 do not have any constrictions, narrow points or the like. This prevents field lines of the induced electric eddy currents from being concentrated and, in this way, avoids heat generation that is stronger in some areas, which would likewise lead to thermal stresses.

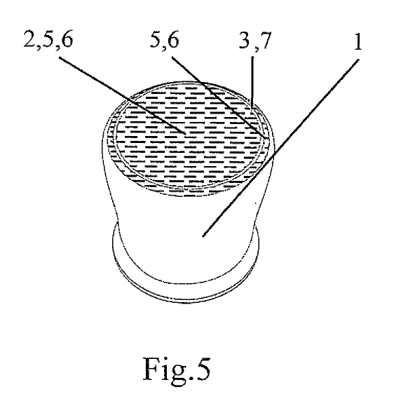

FIG. 5 shows an item of induction cookware 1 according to the invention that is mug-shaped and has a circular, round base 2. The base 2 comprises a surrounding rib 3 around its edge. Within said rib 3, the base is provided with a circular ferromagnetic coating 5; outside of the surrounding rib 3, an annular ferromagnetic coating 5 is present. The two coatings 5 can be regarded as fields 6, which are interrupted by the surrounding rib 3. The coating 5 within the surrounding rib 3 can deviate from the drawing by being annular.

All of the described embodiments of the invention have in common the fact that the field lines which are generated by an induction transmitter are interrupted by the gaps in the ferromagnetic coating 3 and therefore cannot form eddy currents over large areas. This, in turn, results in less coupling-in of energy and, above all, a more even distribution of energy over the surface of the base 2 of the induction cookware 1. The flow of energy is intentionally disrupted, and the advantageous result is that heat-related damage no longer occurs in the porcelain which is preferably used for the induction cookware 1.

### LIST OF REFERENCE SIGNS

1 Induction cookware
2 Base
3 Rib
4 Rib
5 Ferromagnetic coating
6 Field
7 Interruption

1. Induction cookware for keeping food warm that comprises a base formed of a ferromagnetic material, wherein the ferromagnetic material has interruptions and is divided by the interruptions into fields.

2. Induction cookware according to claim 1, wherein the base has on its underside at least one rib which is not located on its edge and the ends of which are distanced from the edge of the base, and wherein the ferromagnetic material is omitted from the at least one rib and is interrupted in the extension of the at least one rib so as to be divided into fields.

3. Induction cookware according to claim 1 wherein the base has on its underside at least one rib which is not located on its edge and the ends of which are distanced from the edge of the base, and wherein that the ferromagnetic material has an interruption within a longitudinal extension of the at least one rib so as to be is divided into fields, which end in the region of the longitudinal extension of the at least one rib.

4. Induction cookware according to claim 1 wherein the fields of ferromagnetic material do not have any constriction points.

5. Induction cookware according to claim 1 wherein the base has a coating of the ferromagnetic material.

6. Induction cookware according to claim 1 wherein the induction cookware is a dinner plate, a drinking vessel, a pan or a bowl.

7. Induction cookware according to claim 1 wherein the base of the induction cookware is angular.

8. Induction cookware according to claim 1 wherein the base of the induction cookware is round.

9. Induction cookware according to claim 1 wherein the ferromagnetic material is surrounded by a ring of ferromagnetic material that does not have any contact with the ferromagnetic material within the ring.

10. Induction cookware according to claim 1 wherein the induction cookware comprises a dielectric material.

11. An induction cookware comprising a base with a ferromagnetic material coating that generates heat upon exposure to an alternating magnetic field from an induction transmitter wherein the coating defines gaps that interrupt field lines of the magnetic field so that heat is distributed over defined areas of the base.

12. The induction cookware according to claim 10 comprising at least one rib that form at least a portion of the gaps.

13. The induction cookware according to claim 11 wherein the gaps divide the base into a plurality of areas wherein each area is heated by the interaction of ferromagnetic material therein and the magnetic field.

14. The induction cookware according to claim 11 wherein the ferromagnetic material coating does not have any constriction points.

15. The induction cookware according to claim 11 wherein the induction cookware is a food container.

16. The induction cookware according to claim 15 wherein the food container is made of a dielectric material.

17. The induction cookware according to claim 11 wherein the ferromagnetic material coating comprises silver oxide.

18. A method of fabricating an induction cookware that comprises the steps of:
providing a food container; and
applying a coating of ferromagnetic material onto a base surface of the food container wherein the coating defines gaps that divide the coating into a plurality of separate areas of the base surface such that alternating magnetic field induces eddy currents in the ferromagnetic material in each of the separate areas which do not have constriction points.

19. The method according to claim 18 wherein the coating of ferromagnetic material has interruptions that limit the eddy currents to within the separate areas.

20. The method according to claim 18 wherein each separate area has a separate eddy current that is induced by the alternating magnetic field.
